(19) United States
(12) Patent Application Publication
(10) Pub. No.: US 2022/0374623 A1
(43) Pub. Date: Nov. 24, 2022

(54) OPTICAL FINGERPRINT IDENTIFICATION STRUCTURE

(71) Applicant: Guangzhou Tyrafos Semiconductor Technologies Co., Ltd., Guangzhou (CN)

(72) Inventors: Hsu-Wen FU, Kaohsiung City (TW); Jun-Wen CHUNG, Tainan City (TW); Yu-Heng CHEN, Taoyuan City (TW); Yufan CHEN, Yilan County (TW); Hung-Wen YANG, Taipei City (TW)

(21) Appl. No.: 17/411,039

(22) Filed: Aug. 24, 2021

(30) Foreign Application Priority Data
May 19, 2021 (TW) 110205760

(51) Int. Cl. G06K 9/00

(52) U.S. Cl. CPC G06K 9/0004; G06K 9/00053

(57) ABSTRACT

An optical fingerprint identification structure is provided, including: a protective glass and an optical fingerprint identification module, wherein the optical fingerprint identification module is located under the protective glass. The protective glass of the present invention is of a thickness. The gap between the protective glass and the optical fingerprint identification module is an air gap. The optical fingerprint identification module further comprises: a receiving lens assembly, an image sensor module, a module housing, and a module housing extension, the receiving lens assembly is located at the top of the optical fingerprint identification module, that is, close to the air gap, and the image sensor module is located below the receiving lens assembly. As such, the size of the optical fingerprint identification structure is reduced, and is applicable to the side of device, so that the usable area on the front and back of the device is increased.

### CROSS-REFERENCE TO RELATED APPLICATION

This application claims the priority of Taiwanese patent application No. 110205760, filed on May 19, 2021, which is incorporated herewith by reference.

### BACKGROUND OF THE INVENTION

### 1. Field of the Invention

The present invention relates generally to an optical fingerprint identification structure, and more particularly, to an optical fingerprint image identification applicable to the side.

### 2. The Prior Arts

Since the development of fingerprint identification technology, it has become the standard equipment of most smart phones. The advantage of fingerprint identification is that the fingerprint is a unique feature of the human body, and the complexity of the fingerprint is sufficient for authentication. In addition, when the reliability needs to be increased, it is only necessary to register more fingerprints and identify more fingers, up to ten, and each fingerprint is unique. Furthermore, scanning fingerprints nowadays is very fast and easy to use, which is one of the main reasons that fingerprint identification technology has the most market share.

Under-screen optical fingerprint identification is currently widely used in AMOLED displays, but it is expected that the under-screen optical fingerprint identification may also be applied to LCD displays with LED backlights in the future. The reason is that various types of panels are now available. The light is projected to the position where the finger touches the panel, and the reflected light is received by the sensor for fingerprint identification, which greatly enhances the application range and applicability of under-screen optical fingerprint identification.

However, as the mobile device screens nowadays have been pursuing high image quality, high definition, and high brightness, the pixel size is getting smaller and smaller for displays, and to avoid light leakage or inter-pixel interference, the structure of the displays is becoming more and more opaque, resulting in insufficient light input to the image sensor, making the under-screen optical fingerprint identification impossible.

For the OLED display panel, to improve the resolution, the pixel size is reduced and the pixel interval (Rib) size is reduced or the display pixel structure is changed from lower light emission to upper light emission, so as to increase the aperture ratio and maintain or increase the pixel brightness after the pixel size is reduced. However, the structure of the display panel makes the originally transparent area become opaque.

In addition to the optical type, there are two other types of fingerprint identification sensor technologies: capacitive type and ultrasonic type. However, these two technologies have poor anti-spoofing capabilities and are not as good as optical type. Optical fingerprint identification can capture a variety of fingerprint change information and human body change information. According to industry ratings, only the optical anti-counterfeiting level can meet the payment standard at present.

At present, on mobile devices, the only solution for installing a side-mounted fingerprint reader is a capacitive sensor. In response to the increasingly vigorous development of mobile payment in the future, it is obvious that the industry's specifications and requirements cannot be met.

Under the development trend of mobile devices with high image quality, high brightness, full screen, narrow bezel, and thinness, it is imperative to resolve the limitations and issues of space regarding side-mounted fingerprint readers.

Therefore, in response to the above-mentioned deficiencies, the present invention is proposed.

### SUMMARY OF THE INVENTION

For achieving the foregoing objectives, the present invention provides an optical fingerprint identification structure, comprising: a protective glass and an optical fingerprint identification module, wherein the optical fingerprint identification module is located under the protective glass. The protective glass of the present invention is of a thickness. The gap between the protective glass and the optical fingerprint identification module is an air gap. The optical fingerprint identification module further comprises: a receiving lens assembly, an image sensor module, a module housing, and a module housing extension, the receiving lens assembly is located at the top of the optical fingerprint identification module, that is, close to the air gap, and the image sensor module is located below the receiving lens assembly.

Preferably, after receiving the light or image, the receiving lens assembly further transmits the light or the image to the image sensor module, and the image sensor module judges or identifies the received light or image.

Preferably, the optical fingerprint identification module is fixed in an application device by installing a fixing element on the of the module housing extension.

Preferably, the module housing extension and a housing of the application device are glued or screwed together to fix the optical fingerprint identification module.

Preferably, an elastic gasket is further provided between the housing of the application device and the optical fingerprint identification module as a buffer.

Preferably, the optical fingerprint identification structure further comprises a light source, and the light source is disposed under the protective glass, and at an appropriate position beside the optical fingerprint identification module, the light source is used to provide light.

Preferably, the light source is arranged on the module housing extension to facilitate the disassembly and assembly of fingerprint identification and reduce the space requirement of assembling.

Preferably, the light is totally reflected in the protective glass, so when the user's finger has not yet touched the surface of the protective glass, the light will not be emitted from the protective glass and will be received by the receiver lens assembly of the optical fingerprint identification module located below.

Preferably, when the user's finger touches the protective glass, because the finger is in contact with the protective glass, the light is no longer totally reflected in the protective glass, so the light will exit the protective glass and passes through the air gap, and will be received by the receiving lens assembly of the optical fingerprint identification module.

Preferably, the protective glass is specially designed with a chamfered corner surface; because the light source is arranged below the side of the panel, the light source can pass through the specially designed chamfered corner surface of the protective glass to further ensure the light generated by the light source can be totally reflected in the protective glass.

Preferably, because the light source is arranged under the protective glass, the protective glass is specially designed with a V-shaped groove at a position corresponding to the light source; the design of the V-shaped groove is for the light generated by the light source to be incident to the protective glass for total reflection inside the protective glass.

Preferably, if the protective glass is a c-axis crystal plane sapphire glass, the angle between a horizontal plane at the top of the V-shaped groove and an inclined plane is between 38.23±0.5 degrees or 57.6±0.5 degrees.

Preferably, if the protective glass is a molten glass, the angle between a horizontal plane at the top of the V-shaped groove and an inclined plane is determined by the angle of a blade.

Preferably, if the protective glass is a quartz glass, the angle between a horizontal plane at the top of the V-shaped groove and an inclined surface is between 42.8±0.5 degrees or 36.8±0.5 degrees.

In summary, the advantages of the optical fingerprint identification structure provided by the present invention mainly lie in that, the optical fingerprint identification technology can be used to reduce the optical fingerprint identification structure of the present invention, which can be used at the side of the application device, increasing the useful area on the front and back of the application device. According to the optical fingerprint identification structure of the present invention, the side of the protective glass is specially designed with a chamfered corner surface, so that the light incident from the side can be totally reflected in the protective glass. The protective glass is specially designed with a V-shaped groove at the position corresponding to the light source, so that the light from below can be totally reflected in the protective glass.

Preferably, the protective glass can be a transparent crystalline, amorphous or plastic material, and is not limited to the aforementioned three materials. The aforementioned sapphire glass, fused glass, and quartz glass are only exemplars.

In order to enable those familiar with the art to understand the purpose, features, and effects of the present invention, the following specific embodiments are used in conjunction with the accompanying drawings to explain the present invention in detail as follows.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of the optical fingerprint identification structure according to the present invention;

FIG. 2 is a detailed schematic view of the optical fingerprint identification structure according to the present invention;

FIG. 3A is a schematic view of the optical fingerprint identification structure according to an embodiment of the present invention;

FIG. 3B is a top view of the optical fingerprint identification structure according to an embodiment of the present invention;

FIG. 4A is a schematic view of the optical fingerprint identification structure according to another embodiment of the present invention;

FIG. 4B is a top view of the optical fingerprint identification structure according to another embodiment of the present invention;

FIG. 5 is a schematic view of the optical fingerprint identification structure according to the present invention in actual use; and

FIG. 6 is a schematic view of the optical fingerprint identification structure according to another embodiment of the present invention in actual use.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

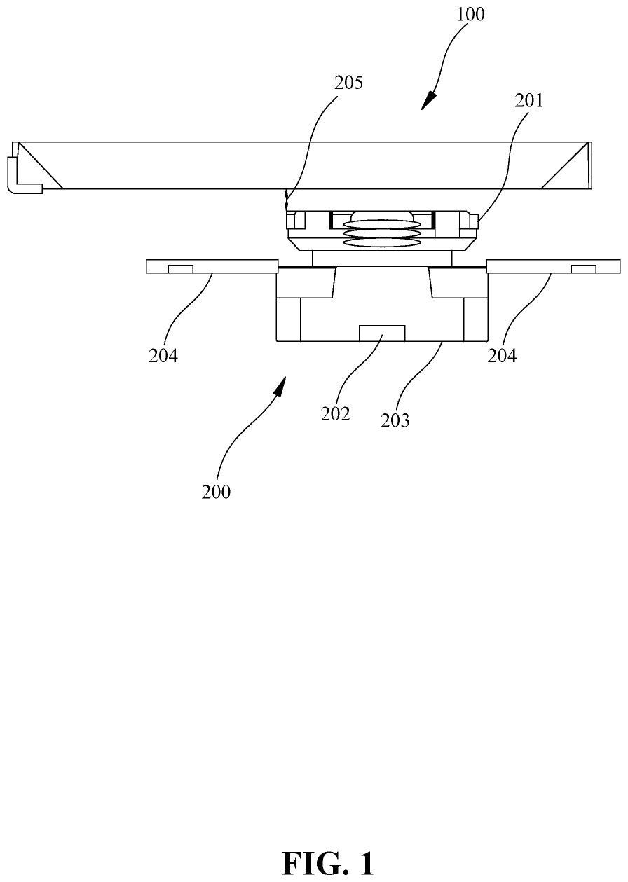

FIG. 1 is a schematic view of an optical fingerprint identification structure according to the present invention. As shown in FIG. 1, the optical fingerprint identification structure according to the present invention includes: a protective glass 100 and an optical fingerprint identification module 200, wherein the optical fingerprint identification module 200 is located under the protective glass 100.

Specifically, refer to FIG. 1, the protective glass 100 according to the present invention has a thickness, and a gap existing between the protective glass 100 and the optical fingerprint identification module 200 is an air gap 205.

The optical fingerprint identification module 200 further includes a receiving lens assembly 201, an image sensor module 202, a module housing 203, and a module housing extension 204, wherein the receiving lens assembly 201 is located in the uppermost part of the optical fingerprint identification module 200, that is, close to the air gap 205, and the image sensor module 202 is located below the receiving lens assembly 201.

Specifically, after receiving the light or image, the receiving lens assembly 201 further transmits the light or image to the image sensor module 202, and the image sensor module 202 judges or identifies the received light or image.

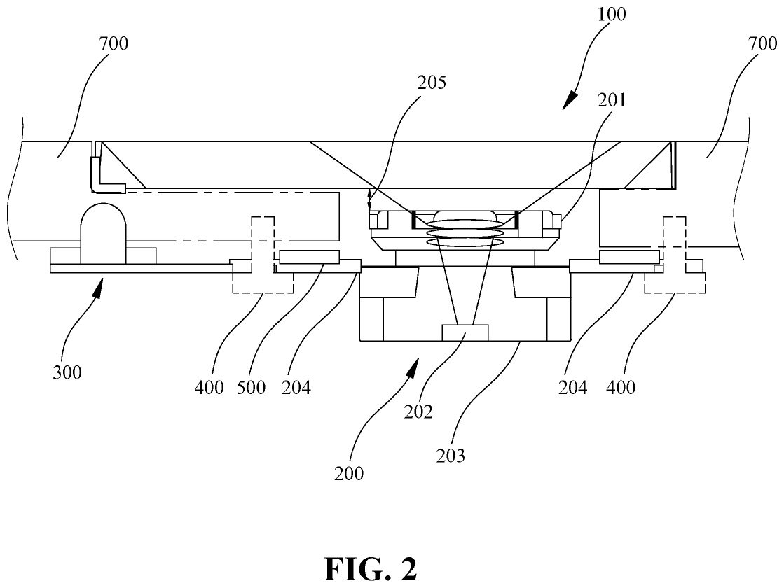

FIG. 2 is a detailed schematic view illustrating the optical fingerprint identification structure of the present invention. FIG. 2 shows the protective glass 100 and the optical fingerprint identification module 200 in the optical fingerprint identification structure of the present invention. Moreover, the optical fingerprint identification module 200 is disposed and fixed to the application device by installing a fixing element 400 on the extension 204 of the module housing.

Specifically, the protective glass 100 is installed in the housing of the application device, and more specifically, is embedded in the housing of the application device.

Specifically, the module housing extension 204 and the housing of the application device are glued or screwed to fix the optical fingerprint identification module 200.

As such, the protective glass 100 and the optical fingerprint identification module 200 are fixed on the application device, and the corresponding position of the protective glass 100 staying above the optical fingerprint identification module 200 is maintained.

Specifically, an elastic gasket 500 is further provided between the housing of the application device and the optical fingerprint identification module 200 as a buffer.

Specifically, the optical fingerprint identification structure of the present invention further comprises a light source 300. The light source 300 is arranged under the protective glass 100, and at an appropriate position beside the optical fingerprint identification module 200. The light source 300 is used to provide light. It is important to note that the light can also be the bright light emitted from the screen of the application device, or emitted by other light-emitting elements in the application device.

Specifically, the protective glass 100 may further be sapphire, molten glass or quartz glass.

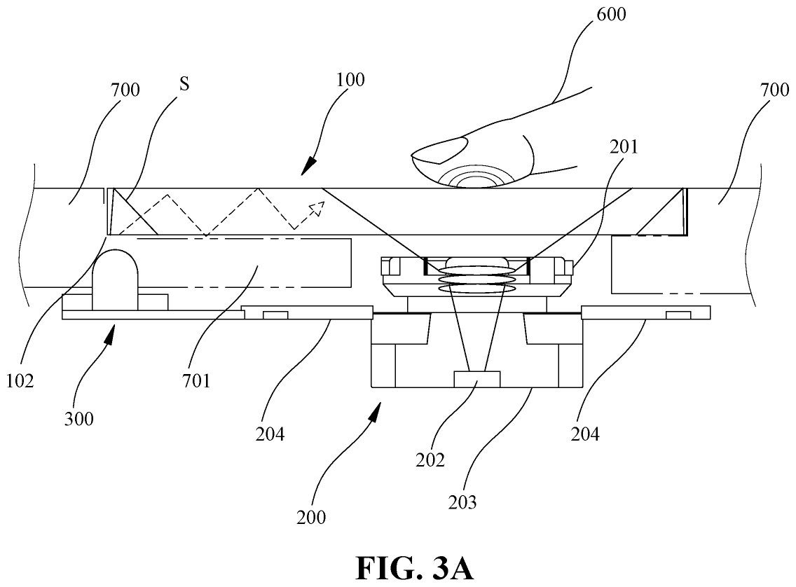

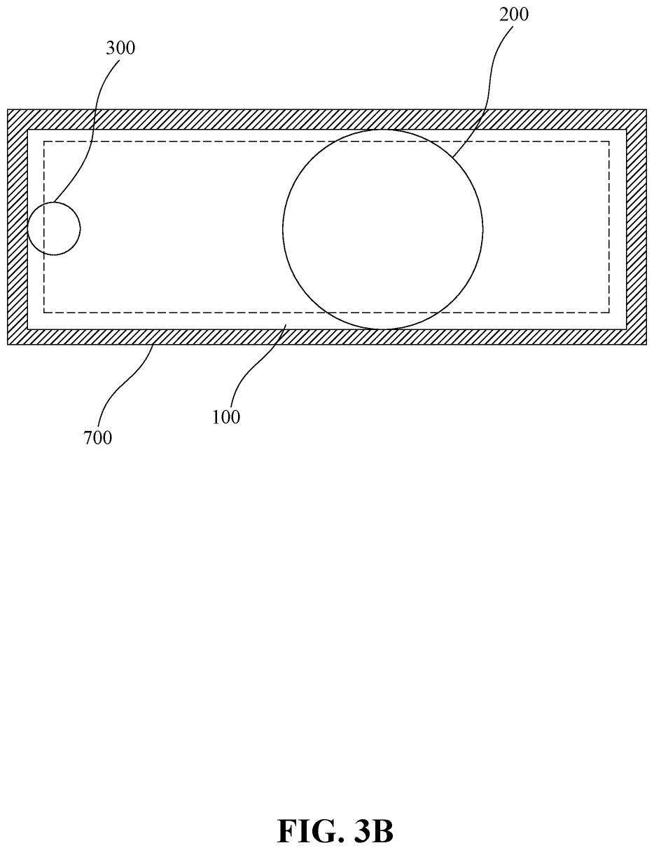

Refer to FIG. 3A and FIG. 3B. FIG. 3A is a schematic view of an embodiment of the optical fingerprint identification structure according to the present invention; FIG. 3B is another schematic view of another view of the embodiment of FIG. 3A. As shown in FIGS. 3A and 3B, in the present embodiment, the optical fingerprint identification structure includes a protective glass 100, a module housing 203, a module housing extension 204, an air gap 205, an optical fingerprint identification module 200, a receiving lens assembly 201, an image sensor module 202, and a light source 300.

Moreover, for the convenience of description, the application device housing, fixing elements and elastic gasket are omitted from the figures.

Specifically, according to the embodiment of the optical fingerprint identification structure of the present invention, the light source 300 provides light, and the light enters the protective glass 100 from the gap below the protective glass 100 where the light source 300 is located, and the light is in total internal reflection inside the protective glass 100. Therefore, when the user's finger 600 has not touched the surface of the protective glass 100, the light will not be emitted from the protective glass 100 but will be received by the receiving lens assembly 201 of the optical fingerprint identification module 200 under the protective glass 100.

Specifically, when the user's finger 600 touches the surface of the protective glass 100, the light will no longer be totally reflected in the protective glass 100 because the finger 600 is in contact with the protective glass 100, so the light will be emitted from the protective glass 100 and passes through the air gap 205, and is received by the receiving lens assembly 201 of the optical fingerprint identification module 200.

Specifically, the receiving lens assembly 201 transmits the received light and images to the image sensor module 202. The image sensor module 202 will specifically analyze and identifies the image, that is, confirm whether the fingerprint of the finger 600 matches with the pre-stored fingerprints in the image sensor module 202 to determine whether the fingerprint identification is successful and whether to unlock the application device.

Refer to FIG. 3B, which is a top view of FIG. 3A. It should be further explained that, as seen in FIG. 3B, the outermost frame represents the housing 700 of the application device, and the inner frame represents the protective glass 100. The panel is embedded in the housing 700 of the application device, the larger circle is the corresponding position of the optical fingerprint identification module 200 under the protective glass 100, and the other smaller circle is the corresponding position of the light source 300, which is also under the protective glass 100.

Specifically, the area of the protective glass 100 directly above the optical fingerprint identification module 200 is the fingerprint identification area, that is, the area of the protective glass 100 where the finger 600 needs to touch.

Specifically, in the present embodiment, the position of the light source 300 is located near the edge of the protective glass 100, and the corresponding position of the light source 300 below the edge of the housing 700 has a hollow 101, that is, the light enters the protective glass 100 from the side. To allow the light provided by the light source 300 to be totally reflected in the protective glass 100, the protective glass 100 is specially designed with a chamfered corner surface S. The light source 300 is arranged below the side of the protective glass 100, and the light can pass through the specially designed chamfered surface S of the protective glass 100, so that the light generated by the light source 300 can be further ensured to be totally reflected in the protective glass 100.

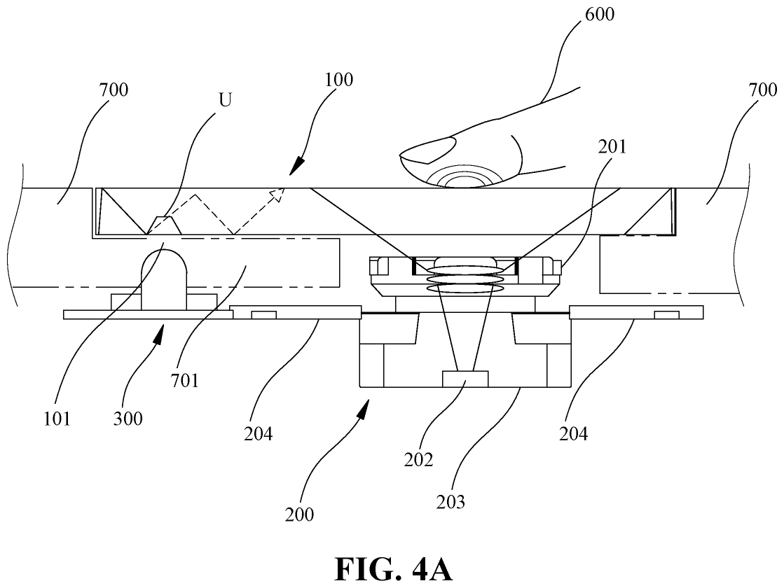

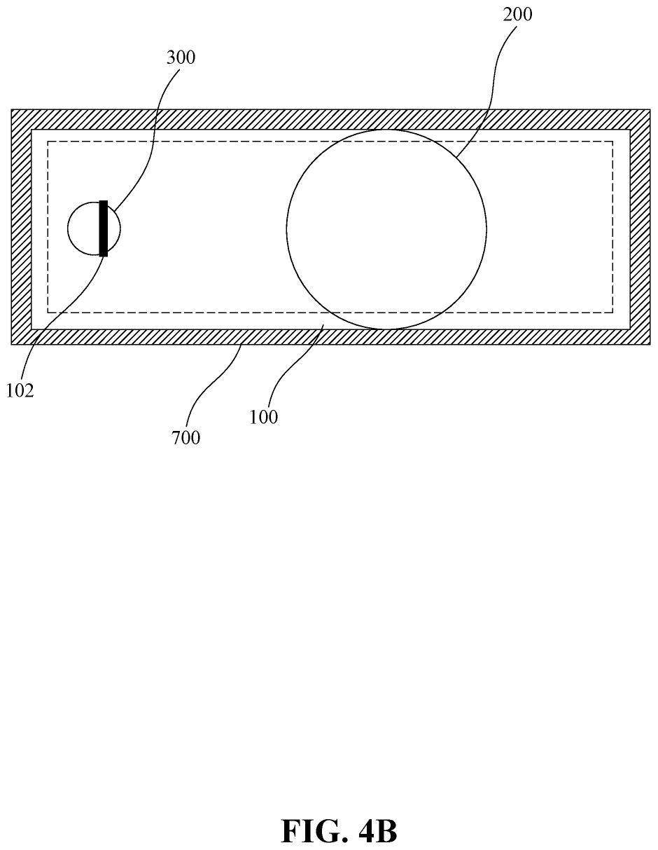

Refer to FIG. 4A and FIG. 4B for another embodiment of the optical fingerprint identification structure of the present invention. FIG. 4A is a schematic view illustrating another embodiment of the optical fingerprint identification structure, and FIG. 4B is another perspective view based on the embodiment of FIG. 4A. As shown in FIG. 4A, the present embodiment also includes a protective glass 100, a module housing extension 204, an air gap 205, an optical fingerprint identification module 200, a receiving lens assembly 201, an image sensor module 202, and a light source 300.

In addition, for the convenience of description, the application device housing, fixing elements and elastic gasket are omitted from the figure.

Specifically, according to the embodiment of the optical fingerprint identification structure of the present invention, the light source 300 provides light, and the light enters the protective glass 100 from the gap below the protective glass 100 where the light source 300 is located, and the light is in total internal reflection in the protective glass 100. Therefore, when the finger 600 has not touched the surface of the protective glass 100, the light will not be emitted from the protective glass 100 but will be received by the receiving lens assembly 201 of the optical fingerprint identification module 200 under the protective glass 100.

Specifically, when the finger 600 touches the surface of the protective glass 100, the light will no longer be totally reflected in the protective glass 100 because the finger 600 is in contact with the protective glass 100, so the light will be emitted from the protective glass 100 and passes through the air gap 205, and is then received by the receiving lens assembly 201 of the optical fingerprint identification module 200.

Refer to FIG. 4B, which is a top view of FIG. 4A. It should be further explained that, as seen in FIG. 4B, the outermost frame represents the housing 700 of the application device, and the inner frame represents the protective glass 100. The panel is embedded in the housing 700 of the application device, the larger circle is the corresponding position of the optical fingerprint identification module 200 under the protective glass 100, and the smaller circle is the corresponding position of the light source 300, which is also under the protective glass 100.

The first difference in the present embodiment is the position of the light source 300. In the present embodiment, the light source 300 is arranged on the protective glass 100 close to the optical fingerprint identification module 200, not on the edge of the protective glass 100, that is, the light from the light source 300 enters the protective glass 100 from below the protective glass 100.

The second difference is that the protective glass 100 is designed differently because of the different positions of the light source 300. As seen from FIGS. 4A and 4B respectively, in FIG. 4A, the protective glass 100 is designed with a V-shaped groove U in the corresponding position of the light source 300.

Specifically, the housing 700 under the protective glass 100 has a hollow 101 at a position corresponding to the light source 300.

Specifically, if the protective glass 100 is a molten glass, the V-shaped groove U is formed by cutting and grinding with a wheel knife, and the angle between a horizontal plane at the top end and an inclined plane is determined by the angle of the blade of the wheel knife.

Specifically, if the protective glass 100 is a c-axis crystal plane sapphire glass, wherein the V-shaped groove U is formed through a wet etching process, and the angle between the horizontal plane and the inclined plane at the top end is between 38.23±0.5 or 57.6±0.5 degrees.

Specifically, if the protective glass 100 is a quartz glass, wherein the V-shaped groove U is formed through a wet etching process, the angle between the horizontal plane at the top and the inclined surface is between 42.8±0.5 degrees or 36.8±0.5 degrees.

In FIG. 4B, from a top view perspective, a scribe line 102 can be seen corresponding to the protective glass 100 above the light source 300, and the scribe line 102 represents a schematic view of the V-shaped groove U viewed from above.

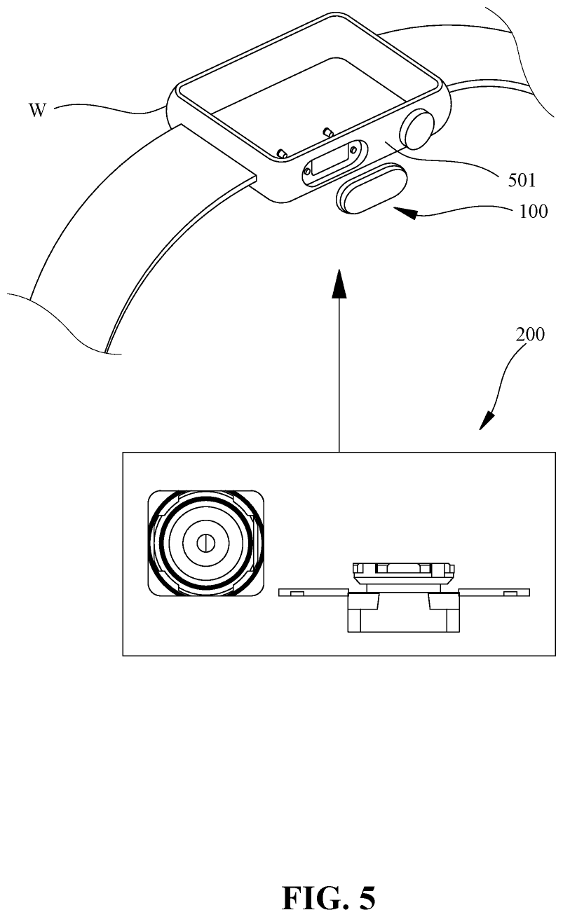

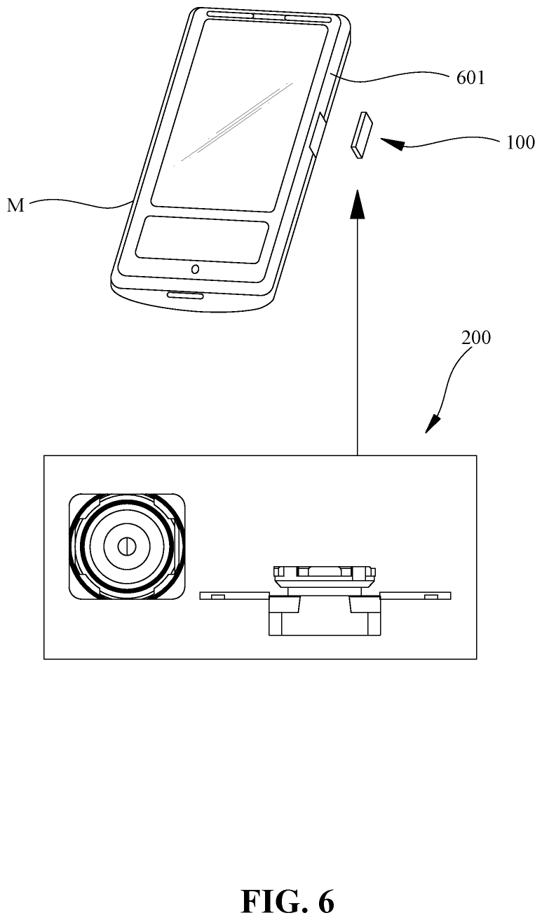

For example, refer to FIG. 5 and FIG. 6. FIG. 5 and FIG. 6 are respectively schematic views of actual applications of the optical fingerprint identification structure of the present invention.

It should be particularly noted that the protective glass 100 can be a transparent crystal, amorphous or plastic material, and is not limited to the aforementioned three materials. The aforementioned sapphire glass, fused glass, and quartz glass are only exemplars.

It is worth mentioning that, for the optical fingerprint identification structure of the present invention, because the technology of fingerprint identification under the optical screen is utilized, the light is totally reflected in the protective glass 100. When the user's finger 600 touches the protective glass 100, the contact between the finger 600 and the protective glass 10 causes the light to no longer be totally reflected, and the light is emitted to the receiving lens assembly 201 of the optical fingerprint identification module 200. The receiving lens assembly 201 not only receives the light, but also receives the image generated by the light, and then the image sensor module 202 further analyzes and determines the received image.

It is worth noting that, because the size of the module applied or used by this technology is relatively small, the present invention further installs the optical fingerprint identification structure on the side of the application device instead of on the front and back to increase the usable area on the front and back of the application device for other applications or purposes.

Refer to FIG. 5. FIG. 5 shows the present invention installed on the smart watch W. As seen from FIG. 5, the optical fingerprint identification structure of the present invention is installed on the side of the surface of the smart watch W. The protective glass 100 can be a separate design or can be integrated with the buttons or touch buttons of the original smart watch W, and an optical fingerprint identification module 200 is installed under the protective glass 100. The light source can be the light emitted from the screen of the smart watch W, or a light source can be additionally installed under the protective glass 100.

Refer to FIG. 6. FIG. 6 shows the present invention installed on the mobile device M. As seen from FIG. 6, the optical fingerprint identification structure of the present invention is installed on the side of the body of the mobile device M. The protective glass 100 can be a separate design or integrated with the buttons or touch buttons of the original mobile device M, and an optical fingerprint identification module 200 is installed under the protective glass 100. The light source can be the light emitted from the screen of the mobile device M, or a light source can be additionally installed under the protective glass 100.

Finally, the technical features of the present invention and achievable technical effects are summarized as follows:

First, with the optical fingerprint identification structure of the present invention, the size of the optical fingerprint identification structure is reduced, and can be applied to the side of the application device, so that the usable area on the front and back sides of the application device is increased.

Second, according to the optical fingerprint identification structure of the present invention, the side of the protective glass of the panel is specially designed with a chamfered corner surface, so that the light incident from the side can be totally reflected in the protective glass.

Third, according to the optical fingerprint identification structure of the present invention, the protective glass of the panel at a position corresponding to the light source is specially designed with a V-shaped groove so that the light entering from below can be totally reflected inside the protective glass.

Although the present invention has been described with reference to the preferred embodiments thereof, it is apparent to those skilled in the art that a variety of modifications and changes may be made without departing from the scope of the present invention which is intended to be defined by the appended claims.

1. An optical fingerprint identification structure installed on an application device, comprising:
a protective glass;
an optical fingerprint identification module located under the protective glass; the protective glass and the optical fingerprint identification module having an air gap in between; the optical fingerprint identification module further comprising a receiving lens assembly, an image sensor module, a module housing, and a module housing extension; the receiving lens assembly being located at a top of the optical fingerprint identification module, that is, close to the air gap, and the image sensor module being located below the receiving lens assembly; and
a light source disposed beside the module housing extension below the protective glass, the application device having a housing with an extended portion located between the protective glass and the module housing extension, the light source is accommodated in a hollow part formed in the extended portion;
wherein when no finger contacts or touches the protective glass, light is totally reflected in the protective glass; when a finger touches the protective glass, the light enters the receiving lens assembly; after the receiving lens assembly receives the light or image, the light or image is further transmitted to the image sensor module, and the image sensor module judges or identifies the received light or image.

2. (canceled)

3. The optical fingerprint identification structure according to claim 1, wherein the module housing extension and the housing of the application device are glued or screwed together to fix the optical fingerprint identification module.

4. (canceled)

5. The optical fingerprint identification structure according to claim 1, wherein the hollow part is formed near an edge of the protective glass, the light source is arranged at the hollow part and below a side of the protective glass, the light enters from the side of the protective glass, and the side of the protective glass is designed with a chamfered corner surface so that the light entering into the protective glass is totally reflected.

6. The optical fingerprint identification structure according to claim 1, wherein the hollow part is formed on the extended portion under the protective glass so that the light source is arranged under the protective glass and the light enters from an underside of the protective glass to form a total reflection.

7. The optical fingerprint identification structure according to claim 6, wherein the protective glass is designed with a V-shaped groove at a position corresponding to the light source so that the light enters the protective glass for total reflection.

8. The optical fingerprint identification structure according to claim 7, wherein the protective glass is a molten glass, the V-shaped groove is formed by cutting and grinding with a wheel knife, and an angle between a horizontal plane at a top end and an inclined plane is determined by an angle of a blade of the wheel knife.

9. The optical fingerprint identification structure according to claim 7, wherein the protective glass is a c-axis crystal plane sapphire glass, the V-shaped groove is formed through a wet etching process, and an angle between a horizontal plane and an inclined plane at a top end is between 38.23±0.5 or 57.6±0.5 degrees.

10. The optical fingerprint identification structure according to claim 7, wherein the protective glass is a quartz glass, the V-shaped groove is formed through a wet etching process, and an angle between a horizontal plane at a top and an inclined surface is between 42.8±0.5 degrees or 36.8±0.5 degrees.

11. The optical fingerprint identification structure according to claim 1, wherein the application device has a display surface and a thin side, and the protective glass and the optical fingerprint identification module are installed on the thin side of the application device with a surface of the protective glass perpendicular to the display surface.
